(19) United States
(12) Patent Application Publication
(10) Pub. No.: US 2026/0240123 A1
(43) Pub. Date: Aug. 20, 2026

(54) KIT AND ASSEMBLY FOR DISPENSING FRESH WATER TO FOWL

(71) Applicant: BACKYARD FARM SUPPLY COMPANY, LLC, Cornelius, NC (US)

(72) Inventors: Frank CARDAROPOLI, Mooresville, NC (US); Albert BRUNNER, Charlotte, NC (US); Laura CARDAROPOLI, Mooresville, NC (US)

(21) Appl. No.: 19/157,187

(22) PCT Filed: Feb. 16, 2024
(86) PCT No.: PCT/US2024/016098

§ 371 Date: Aug. 15, 2025

Related U.S. Application Data
(60) Provisional application No. 63/485,673, filed on Feb. 17, 2023.

(51) Int. Cl. A01K 39/02

(52) U.S. Cl. CPC A01K 39/02

(57) ABSTRACT

This specification discloses a kit for assembling into a water dispenser for providing fresh water to fowl such as chickens. The kit comprises a water reservoir, at least one distribution arm, and a valve to connect to a water source. The water reservoir comprises a top end, a bottom end, a connector port and at least one sidewall. The at least one distribution arm comprises a first end, a second end, at least one sidewall, and at least one drinking valve. The at least one distribution arm can mechanically connect to the water reservoir. The at least one drinking valve is located in the at least one distribution arm sidewall. The water reservoir can be connected to the water source.

### CROSS REFERENCES AND PRIORITIES

This application claims priority from United States Provisional patent application number 63/485,673 filed on 17 Feb. 2023, the teachings of which are incorporated herein in their entirety.

### BACKGROUND

Providing a fresh source of water for chickens, ducks, guinea hens and other fowl is a significant concern for many farmers. The simplest method of providing fresh water involves placing buckets, bowls or troughs of water into the pen, brooder or other holding area. This simple approach has been used for many years, but it requires regular flushing, cleaning and re-filling of the bucket, bowl or trough. If the bucket, bowl or trough is not flushed, thoroughly cleaned and re-filled on a regular basis the stagnant water becomes dirty, can be contaminated with fecal matter and can be overrun by bacteria and insects that can transmit serious diseases to the fowl. This is of particular concern for young fowl that are kept and raised in a brooder containing a fresh water source where the young fowl are more likely to soil the water source and are more susceptible to disease. Additionally, buckets, bowls and troughs of water can freeze in cold temperatures requiring a time consuming process of thawing or breaking up the frozen water to give the fowl access to drinkable water.

Some have proposed an article that provides a self-contained water source that can be released through a valve into a common trough when actuated by the fowl. One such device is proposed in U.S. Pat. No. 4,829,933 to Van der Veer and comprises a float operated actuator for a drinking nozzle that is manually actuated to release water into a drinking trough. This approach suffers in that once the water is released to the common trough it can become contaminated with dirt, bacteria and fecal matter.

Others have proposed an article which is completely self contained and provides water when actuated by the fowl. Articles have existed at least since the 1940's for providing water to fowl through a self contained system. These systems generally make use of a valve or a series of valves which can be actuated by the fowl to release a flow of water.

For instance, U.S. Pat. No. 2,486,729 to Beckley describes a poultry-watering device comprising a water pipe connected to a low pressure water supply system with a series of fitted fixtures that are sensitive to the contact of the fowl.

U.S. Pat. No. 3,322,101 to Eagles et al. describes a nozzle having a nipple that is attached to an unknown source of water. An animal contacts the nipple, opening the valve and permitting water to flow out of the valve.

U.S. Pat. No. 3,418,977 to Godshalk describes a poultry watering device comprising a rigid valve body member inserted through a port in an elongated conduit.

The fowl pushes upwardly with its beak against the valve to unseat the valve element and permit the flow of water through the valve.

U.S. Pat. No. 4,416,221 to Novey describes a nipple type waterer and valve having an end fitting accessible to an animal with the tip being in the form of a nipple that can be displaced laterally to open the valve.

U.S. Pat. No. 4,984,537 to Steudler, Jr. describes a nipple drinker including a passage, a ball valve which closes the passage when seated and a ball valve actuating stem having a head and a pin. Fowl can actuate a stem to unseat the ball valve to initiate water flow.

U.S. Pat. No. 6,058,881 to Thompson describes a watering valve for birds and small animals having a spring biased metering pin with a tubular actuator stem. The bird or animal applies a demand force to the actuator stem to displace the stem and initiate water flow.

U.S. Pat. No. 6,308,657 to Schumacher et al. describes a drinking valve having a casing, an acceptance part, a connecting part and a snap-in connection.

United States Patent Application No. 20140239215 to Cardaropoli discloses an alternative drinking valve with a valve body, an actuating pin, a receiver pin, and a ball.

### SUMMARY

This specification discloses a kit for assembly into a water dispenser. This kit comprises a water reservoir comprising a top end, a bottom end, and at least one sidewall, and a connector port.

The kit further comprises at least one distribution arm comprising a first end, a second end, at least one distribution arm sidewall,

There is at least one drinking valve configured to be attached to a distribution port with the at least one distribution arm is configured to be mated with the connector port.

It is further disclosed that the connector port further comprises a lug and that the lug can be an angled lug or a straight lug. The lug may also have a lug stop.

It is further disclosed that the at least one distribution arm has a lug that has an optional lug stop and/or an optional lug lock.

The kit may further comprise a gasket configured to form a seal between the connector port and the distribution arm.

It is further described that the kit may have a water level control mechanism which can be attached to the top or bottom of the water reservoir. Alternatively, the water level control mechanism may be attached to a lid fitting over the water reservoir.

The is preferably void of a separate solvent adhesive for mating the connector port to the distribution arm.

A mounting bracket is further disclosed for the kit.

Also disclosed is the assembly of any of the kits as claimed.

### BRIEF DESCRIPTION OF FIGURES

FIG. 1 is a perspective view of a prior art embodiment of the article described herein.

FIG. 2 is an exploded view of the prior art embodiment of FIG. 1.

FIG. 3 is a cut away view the prior art embodiment of FIG. 1.

FIG. 4 is a perspective view of the body of the invented water dispenser.

FIG. 5 is an exploded view of the perspective view of the invented water dispenser.

FIG. 6 is a bottom view of an embodiment of the water dispenser.

FIG. 7 is a front facing view of an embodiment of the invented water dispenser.

FIG. 8 is a cutaway of the perspective view of an embodiment of the invented water dispenser.

FIG. 9 is a cutaway of the frontal view of an embodiment of the invented water dispenser.

FIG. 10 is a perspective top view of an embodiment of the invented water dispenser.

FIG. 11 is a perspective view of a distribution arm.

FIG. 12 is perspective view of the inside of a distribution arm.

FIG. 13 is a cutaway of a distribution arm.

FIG. 14 is a side view of an alternative embodiment of the water dispenser.

FIG. 15 is a bottom perspective view of an alternative embodiment of the water dispenser.

FIG. 16 is a bottom view of an alternative embodiment of the water dispenser.

FIG. 17 is a top perspective view of an alternative distribution arm of the water dispenser.

FIG. 18 is a bottom perspective view of an alternative distribution arm of the water dispenser.

FIG. 19 is a side view of an alternative embodiment of the water dispenser.

FIG. 20 is a top perspective view of the lid and valve of an alternative embodiment of the water dispenser.

FIG. 21 is a bottom perspective view of the lid and valve of an alternative embodiment of the water dispenser.

FIG. 22 is a top perspective view of the lid of an alternative embodiment of the water dispenser.

FIG. 23 is a top perspective view of an alternative valve of an alternative embodiment of the water dispenser.

FIG. 24 is a top perspective view of a mounting bracket.

FIG. 25 is a bottom perspective view of an alternative embodiment of the water dispenser in a mounting bracket.

FIG. 26 is a top perspective view of an alternative embodiment of the water dispenser in a mounting bracket.

FIG. 27 is a side perspective view of a cap.

FIG. 28 is an inside view of a cap.

### DETAILED DESCRIPTION

In this specification and in the claims, the terms “mated to” or “mated with” are synonymous when discussing the threads of one component mated to or mated with the threads of another component. The term “mated to” or “mated with” means that the threads of the two components are appropriately designed in terms of pitch, threads per inch, thread width and thread depth so that the two components are firmly connected with each other meaning that there is no looseness or play when the components are pushed and then pulled in opposing directions. In terms of the art, phrases such as “tight fit”, “snug fit”, “torqued” and “tightened” can be used to describe when the threads of the two components are mated to or mated with one another.

Male threads are those threads which are on the outer surface of a cylindrical component. Female threads are those threads which are on the inner surface of a cylindrical component. When mated, the outside diameter of the cylinder having the male threads, not including the depth of the male threads, is less than the inside diameter of the cylinder having the female threads, not including the depth of the female threads.

The prior art describes an article 10 for providing fresh water to fowl that is enclosed to prevent contamination of the water supply by dirt, fecal matter or microorganisms thereby eliminating the need for constant flushing, cleaning and refilling of a water source.

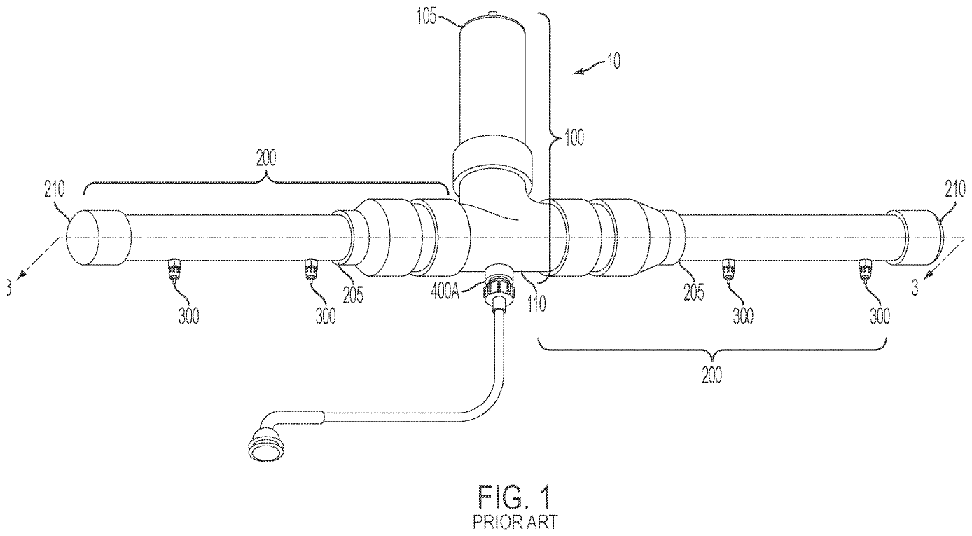

FIG. 1 depicts one embodiment of a prior art article for providing fresh water to fowl disclosed in this specification comprising a water reservoir 100, at least one distribution arm 200 comprising at least one drinking valve 300, and a water level control mechanism 400A.

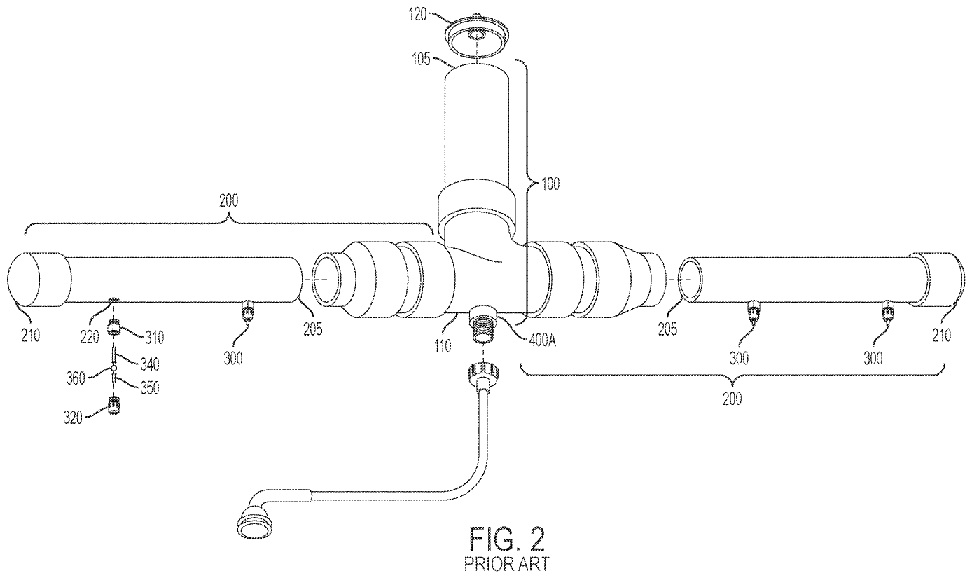

As shown in FIG. 2, the prior art water reservoir comprises a top end 105, a bottom end 110, at least one sidewall, and a cap 120.

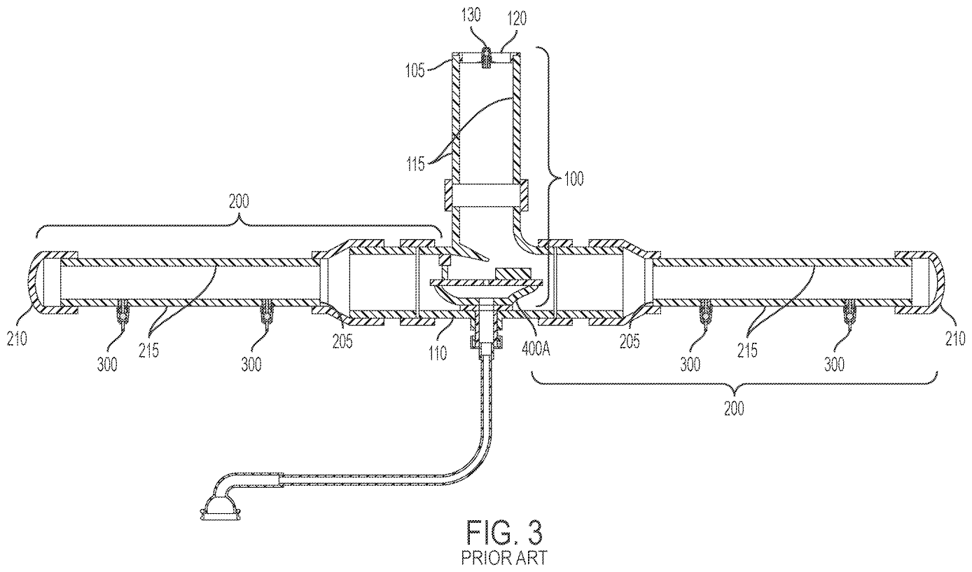

As shown in FIG. 3, the at least one sidewall 115 has a length dimension, a width dimension, an inner surface and an outer surface defining the exterior shape of the water reservoir. The exterior shape of the water reservoir is not considered to be important. In one embodiment, the water reservoir has a cylindrical shape wherein there is a single sidewall running continuously in a circular or oval pattern. In another embodiment the water reservoir may have a rectangular, triangular, trapezoidal, hexagonal or octagonal shape wherein there are multiple side walls and the sidewalls are attached on their longitudinal edges to form the desired shape. In either event, the at least one sidewall provides for a water reservoir having a hollow interior running from the water reservoir top end to the water reservoir bottom end.

The prior art cap 120 is adapted to cover the water reservoir top end 105. The cap may be designed such that at least a portion of the cap fits inside the hollow interior of the water reservoir as shown in FIG. 2. In such an embodiment, the portion of the cap that fits inside the water reservoir is of similar shape and dimension as the inner surface of the at least one sidewall. The cap may also be threaded into the water reservoir top end. In such an embodiment the inner surface of the at least one sidewall has female threads at the water reservoir top end, the portion of the cap that fits inside the hollow interior of the water reservoir has male threads and the male threads of the cap are mated to the female threads of the at least one sidewall.

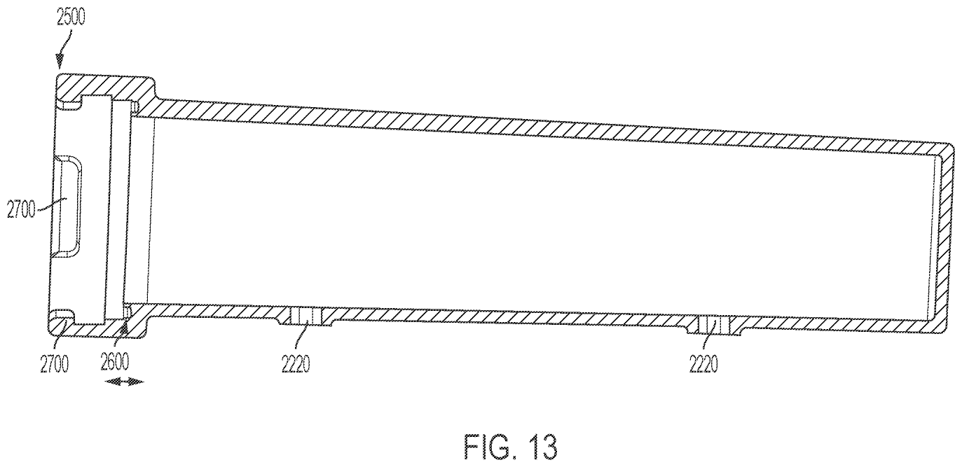

In one embodiment the cap 120 further comprises a vent 130 as shown in FIG. 3. One preferred vent is an inverted ball check valve having a first end, a second end, a hollow interior, and a ball. When the vent is closed, the ball closes the vent such that air, liquids, and solid debris cannot enter the water reservoir and air and water cannot exit the water reservoir. When pressure in the water reservoir increases at the water reservoir top end, the ball is forced out of the ball seat thereby allowing air and/or water to exit the water reservoir. This is particularly useful during the process of filling the water reservoir. If air and/or water are not allowed to exit the water reservoir through the vent, pressure will build in the water reservoir during filling which may result in the cap being dislodged. One such inverted ball check valve is a modified form of the preferred embodiment of the drinking valve described below and shown in FIG. 13 where the receiver pin and the actuator pin of the preferred drinking valve are removed.

The prior art's at least one distribution arm extends past the water reservoir sidewall. As shown in FIG. 2, the at least one distribution arm 200 comprises a first end 205, a second end 210, at least one sidewall and at least one drinking valve 300. As shown in FIG. 3, the at least one sidewall 215 has a length dimension, a width dimension, an inner surface and an outer surface defining the exterior shape of the distribution arm. The prior art did not consider the exterior shape of the at least one distribution arm is not considered to be important except that the exterior shape of the at least one distribution arm should be such that the at least one distribution arm can be connected to the water reservoir 100 in a manner such that the connection between the at least one distribution arm and the water reservoir creates a water-tight seal at standard atmospheric conditions-sea level, 25° C.

In this prior art embodiment, the at least one distribution arm has a cylindrical shape wherein there is a single sidewall running continuously in a circular or oval pattern. The at least one sidewall provides for an at least one distribution arm having a hollow interior running from the distribution arm first end to the distribution arm second end.

In the prior art embodiment of FIG. 3, a first portion of the at least one distribution arm is joined in a unitary manner to the water reservoir sidewall at the water reservoir sidewall bottom end. A second portion of the at least one distribution arm is not joined in a unitary manner to the water reservoir. The first portion of the at least one distribution arm is connected to the second portion of the at least one distribution arm such that the connection creates a water-tight seal.

In one prior art embodiment, the water-tight seal may be created by closely matching the shape and size of the two portions of the distribution arm and bonding them using a sealant material such as silicone, PVC cement, or both. One preferred PVC cement is Medium-Clear PVC Cement #31017 available from Oatey of Cleveland, Ohio, USA.

The at least one distribution arm is preferably sealed at the end which is not attached or joined in a unitary manner to the water reservoir. In the prior art embodiment of FIG. 3, the seal is a cap (210) that fits around the outer surface of the distribution arm sidewall is of similar shape and dimension as the outer surface of the at least one sidewall.

The drinking valve 300 can be any drinking valve known in the art and those yet to be invented. Examples of drinking valves considered useful for the current invention include those disclosed in U.S. Pat. No. 3,322,101 to Eagles et al., U.S. Pat. No. 3,418,977 to Godshalk, U.S. Pat. No. 4,416,221 to Novey, U.S. Pat. No. 4,984,537 to Steudler, Jr., U.S. Pat. No. 6,058,881 to Thompson and U.S. Pat. No. 6,308,657 to Shumacher et al., the teachings of each of which are incorporated herein by reference. It is preferred that the drinking valve not be of a design which requires a squeezing force to actuate the flow of water, such as a baby bottle nipple. Preferably the drinking valve has a self-sealing actuating mechanism which opens the drinking valve when an actuating force is applied to the actuating mechanism and automatically closes the drinking valve when the actuating force is released. Examples of such an actuating mechanism are disclosed in U.S. Pat. No. 4,984,537 to Steudler, Jr. having a ball valve closing the passage when seated on at least one valve seat, and a ball valve actuating stem having a head and a pin, whereby small and large fowl and/or animals can actuate the stem to unseat the ball valve in proportion to the force applied to the stem.

The drinking valve 300 may be attached to the distribution arm 200 in a number of manners. In one embodiment, the distribution arm comprises at least one valve hole 220 having female threads while the outer surface of the drinking valve has male threads and the drinking valve male threads are mated to the at least one valve hole female threads. In another embodiment, the distribution arm comprises a male protrusion having male threads that is attached to the distribution arm sidewall outer surface and protrudes outwardly therefrom. In such an embodiment the inner surface of the drinking valve has female threads and the drinking valve female threads are mated to the at least one male protrusion male threads. In another embodiment, a portion of the drinking valve is joined to the at least one distribution arm in a unitary manner such as by injection molding.

In a preferred embodiment, the drinking valve 300 has a receiver 310, a valve cap 320, and an actuating mechanism. An actuating mechanism is the specific valve configuration and components which allows the flow of water to be turned on and off. In one embodiment shown in FIG. 13 the actuating mechanism comprises a receiver pin 340, an actuating pin 350 and a ball 360.

In the preferred drinking valve embodiment the receiver 310 has a first end 311, a second end 312 and a receiver hole having a receiver hole diameter. The receiver hole passes through the receiver from the receiver first end to the receiver second end. In one embodiment the receiver hole has a first receiver hole diameter at the receiver first end and a second receiver hole diameter at the receiver second end where the second receiver hole diameter is greater than the first receiver hole diameter.

In one embodiment of the preferred drinking valve the inner surface of the receiver hole has female threads at the receiver second end. In another embodiment of the preferred valve, the outer surface of the receiver second end has male threads. The receiver hole further comprises a receiver pin seat having a receiver pin seat diameter. The receiver pin seat acts as a stop to prevent the receiver pin from advancing further into the receiver.

The receiver may further comprise a gasket ridge in which a gasket or O-ring may be seated.

The receiver 310 may be attached to the distribution arm 200 in a number of manners. In one embodiment, the distribution arm comprises at least one valve hole 220 having female threads while the outer surface of the receiver first end has male threads and the receiver first end male threads are mated to the at least one valve hole female threads. In another embodiment, the distribution arm comprises a male protrusion having male threads that is attached to the distribution arm sidewall outer surface and protrudes outwardly therefrom. In such an embodiment the inner surface of the receiver first end has female threads and the receiver first end female threads are mated to the at least one male protrusion male threads. In another embodiment, the receiver is joined to the at least one distribution arm in a unitary manner such as by injection molding.

Because the water is self-contained in the reservoir and the drinking arm it is less susceptible to being contaminated with dirt, fecal matter or bacteria. In a preferred embodiment, the water flowing from the drinking valve does not drip into a common bowl or trough and in fact the preferred method for watering the fowl is to do so in the absence of a common bowl or trough which may or may not be attached to the assembled article. Accordingly, the supply of water for the fowl will remain fresh without the need to continually flush, clean and re-fill a bucket, bowl or trough.

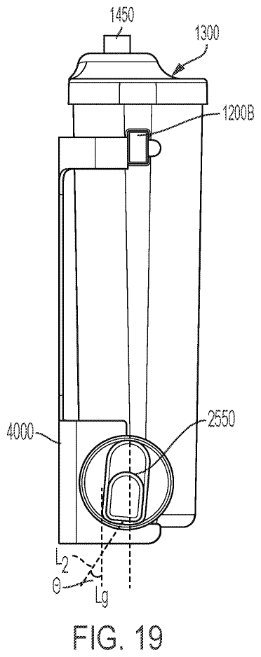

Each distribution arm 200 may comprise one or more than one drinking valve 300. The number of drinking valves connected to each distribution arm is not considered important. One of ordinary skill will recognize that the number of drinking valves per distribution arm and the number of distribution arms can be varied according to the number of animals that are obtaining water from the device. In the prior art embodiment, each of the drinking valves is attached to the distribution arm such that each drinking valve is substantially perpendicular to the ground. In an alternative non-prior art embodiment (FIG. 19) the drinking valves may be attached to the distribution arm at a plurality of angles in the range of about 1° from perpendicular to the ground to about 45° from perpendicular to the ground.

In a preferred embodiment the valve cap 320 is red. In a more preferred embodiment the valve cap and the receiver 310 are red. In an even more preferred embodiment, the valve cap and receiver are red and the distribution arm 200 is white. The coloring may be achieved by using materials which are inherently red or white, adding a colorant to the composition used to make that portion of the article or painting or layering a colored material onto that portion of the article. It is believed that the red color draws the fowl with the preferred contrasting red and white colors of the distribution arm and the receiver/valve cap best attracting the fowl to the apparatus making it more likely that they will drink from the apparatus.

It is preferred that the water reservoir 100, the distribution arm 200, the receiver 310 and the valve cap 320 comprise a plastic material. Preferred plastics for use in the water reservoir, the distribution arm, the receiver and the valve cap include polyvinyl chloride, foamed polyvinyl chloride, the polyethylenes, the foamed polyethylenes and combinations thereof.

The water level control mechanism 400A or 400B is any device that regulates the hydrostatic pressure applied to the drinking valve 300 based upon the amount of water in the device when the drinking valve is in the closed position. If too much water is contained in the device, the hydrostatic pressure that is applied to the drinking valve may make it difficult for the fowl to open the drinking valve and obtain water. Conversely, if not enough water is contained in the device, the hydrostatic pressure applied to the drinking valve may be such that the valve can be opened too easily, thereby allowing water to spill from the valve and become wasted. One of ordinary skill will recognize that the water level control mechanism serves the dual purpose of controlling the water level in the device as well as the hydrostatic pressure at the drinking valves. The water pressure at the drinking valves is a function of the number of drinking valves and the water level in the device. Accordingly, as more drinking valves are added to the device, the water level should be increased to ensure that adequate pressure is kept at each drinking valve. Preferably the water level control mechanism is an anti-siphon fill valve.

In the prior art embodiment shown in FIGS. 1 to 3, the water level control mechanism is a floatless ballcock fill valve 400A. One such floatless ballcock fill valve is a K830-15 Mini Pilot Anti-Siphon Toilet Fill Valve available from The Keeney Manufacturing Company, Newington, Connecticut, USA. The floatless ballcock fill valve is located at the bottom end of the water reservoir 110. The bottom end of the water reservoir will have a fill valve hole to allow the floatless ballcock fill valve to be attached to an external water source. The floatless ballcock fill valve includes a diaphragm pressure sensing mechanism that opens the fill valve when the hydrostatic pressure in the water reservoir decreases beyond a pre-determined level thereby refilling the water reservoir and increasing the hydrostatic pressure applied to the drinking valve to the desired level. The floatless ballcock fill valve may also include a fill hose which extends out from the floatless ballcock fill valve and into one of the plurality of distribution arms.

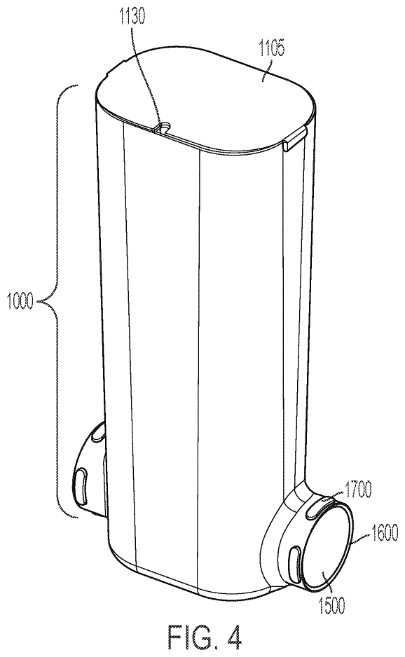

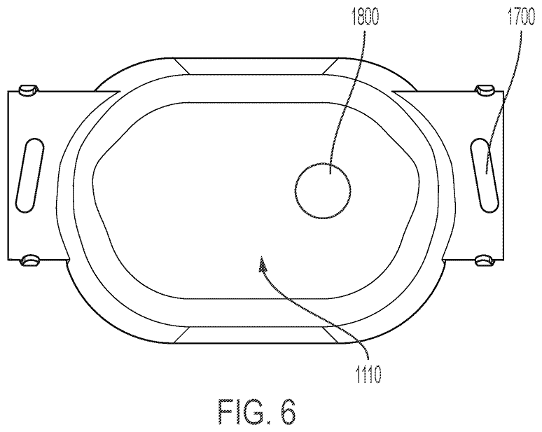

In the non-prior art embodiment shown in FIGS. 4 to 6, the water level control mechanism is a float fill valve 400B. One preferred float fill valve is a Kerick Float Valve M052 available from Kerick Valve, Inc., Jacksonville, Florida, USA. The float valve is located at the top end of the water reservoir 105. The sidewall of the water reservoir will have a fill valve hole located near the top end of the water reservoir to allow the float fill valve to be attached to an external water source. The float fill valve includes a float that closes the fill valve when the water level in the water reservoir is at the level desired to maintain the appropriate hydrostatic pressure and opens the fill valve when the water level in the water reservoir falls below the desired level. Accordingly, by automatically re-filling the water reservoir, the drinking valves will always have the appropriate amount of hydrostatic pressure applied to them when they are in the closed position.

In one embodiment the external water source is a hose attached to a traditional water spigot. The water spigot can be attached to the main water supply for a residential, agricultural or industrial establishment such as a well water source or a municipal water system. The water spigot can remain open and the water level control mechanism will regulate the amount of water that flows out of the spigot into the water reservoir. In embodiments using a float fill valve and a traditional water spigot, the system may be adapted to withstand the high pressure (greater than 5 psi) of the water entering the water reservoir from the traditional water spigot. Traditionally this can be achieved by adapting the type of the feeder hose and valve fittings.

In another embodiment the external water source is a tank [ ]500, which could be a barrel, a bucket, a pail, or other vessel, comprising a bottom surface, at least one sidewall and a top surface. The top surface may be a solid unitary surface, (i.e. covered), it may be a screened surface or it may be open to the atmosphere. A screened surface is preferred in order to allow rain water to collect in the tank while simultaneously preventing contaminants, particularly mosquitos, ants, flies, bees, larvae, and other insects from contaminating the water supply. Preferably the screened surface comprises a screen having a screen mesh size to exclude even the “no see um” or biting midges. This screen size is typically no larger than 30 mesh, with no larger than 25 mesh being preferred and no larger than 20 mesh being a most preferred size. One preferred screen is white Noseeum Mosquito Netting Fabric from the Online Fabric Store, at http://www.onlinefabricstore.net/white-noseeum-mosquito-netting-fabric-.htm, 12 May 2014.

Allowing rain water to collect in the tank reduces or eliminates the need to continuously re-fill the tank. The water reservoir may be connected directly to the tank by a series of fittings or hoses. Preferably, the water reservoir is connected to the tank by a hose. In one embodiment the hose runs from the bottom surface of the tank and a float fill valve attached to the sidewall of the water reservoir. In another embodiment, the hose runs from the bottom surface of the tank and a floatless ballcock fill valve attached to the bottom end of the water reservoir. In still another embodiment, one end of the hose is inserted into the tank through the tank top surface and the other end of the hose is inserted into the top end of the water reservoir. The portion of the hose that is not inserted into the top end of the water reservoir or the top of the tank is maintained at a height above the top surface of the tank and the top end of the water reservoir so that water may be siphoned out of the tank, through the hose and into the water reservoir without the need for a fill valve.

The arrangement of the tank to the water reservoir should be such that the water will flow from the tank to the water reservoir without external assistance such as a pressurized water source, increased air pressure, a pump, or other water conveying device. For example, placing the tank above the water reservoir relative to the ground allows the water to flow via gravity from the tank into the water reservoir when the at least one drinking valve is open. Locating the tank below the water reservoir requires use of the siphoning principles well understood in the art. The drawback of siphoning is that, if the water tank is ever empty, the siphon is broken and needs to be restarted.

In this manner, the watering system is mobile and can be located in any outdoor field far away from a pressurized water source. It is even conceived that a solar powered water pump could be used to deliver a low amount of water from a nearby stream, thus keeping the tank filled with water and supplying the water reservoir via the water level control mechanism to maintain a relatively constant pressure at the at least one drinking valve.

It is preferred that the assembly provides a barrier against visible light and its outside ranges defined as light in the range of 350 nm to 750 nm that can reach the water. The visible light and its outside ranges foster the growth of photosynthetic organisms, such as algae, in the water supply. These photosynthetic organisms can cause health problems for the animals. In this regard, it is preferred that the water be entirely enclosed from the visible light and that the various components, including the water reservoir, the cap, the distribution arm, and the valves be made of materials which block the visible light and its outside ranges from passing through the component. Blocking visible light and its outside ranges means that at least 50% of the light in the range of 350 nm to 750 nm does not pass through the component, with at least 75% being more preferred, and 85% being even more preferred, and 95% being more preferred with 100% being the most preferred. 50% of the light means 50% of the total light, not 50% of each wavelength. This can be done by using inherently opaque materials, using inherently properly colored materials, adding an additive which blocks or absorbs the light, or painting or layering a colored material onto that portion of the article so that it blocks the visible light and its outside ranges.

In one embodiment, the assembly further comprises an electric heater. The electric heater comprises a source of electricity and a heating element. One example of an electric heater is a 44 watt foil heater. The 44 watt foil heater comprises a heater plug which extends out of the reservoir and can be connected to a standard electric outlet. In one embodiment the heating element extends into the water reservoir. In a further embodiment the heating element extends into the at least one distribution arm. In still a further embodiment the heating element extends into both the water reservoir and the at least one distribution arm. The heating element preferably has a thermal conductivity greater than 50 Btu/(hr.-° F.-ft) at 68° F. In a more preferred embodiment the heating element has a thermal conductivity greater than 100 Btu/(hr.-° F.-ft) at 68° F. In a most preferred embodiment the heating element has a thermal conductivity greater than 150 Btu/(hr.-° F.-ft) at 68° F.

In one preferred embodiment the heating element comprises copper, with the heating element preferably comprising more than 90% copper by weight with the heating element comprising more than 99% by weight copper being more preferred and a heating element made of 100% copper by weight being most preferred. The heating element may also be considered to consist essentially of copper, meaning that there could be trace amounts of other materials including copper oxide. In another preferred embodiment, the heating element comprises more than 90% silver by weight with the heating element comprising more than 99% by weight silver being more preferred and a heating element made of 100% silver by weight being most preferred. The heating element may also be considered to consist essentially of silver, meaning that there could be trace amounts of other materials including silver oxide. In another preferred embodiment the heating element is silver coated, an example of which is a core comprising copper with a silver coating, wherein the amount by weight of silver in the coating to the amount of copper in the core is in the range of 0.001 to 0.1, with 0.001 to 0.01 the most preferred. Since the amount of the silver may also be 0, in the case of just the heating element, the heating element may have the amount by weight of silver in the coating to the amount of copper in the core is less than 0.1, with less than 0.01 the most preferred.

In one preferred embodiment the assembly comprises a heating element which extends into the at least one distribution arm used in conjunction with a plurality of drinking valves wherein at least one drinking valve comprises a heat transfer pin of the specifications and compositions described earlier. Preferably each drinking valve of the plurality of drinking valves comprises a heat transfer pin. In such an embodiment it is preferred that the heating element be silver coated. It is further preferred that the heat transfer pin comprises greater than 90% copper by weight. In one embodiment the heat transfer pin may be silver coated. In one embodiment the heating element is in direct contact with the heat transfer pin of each of the plurality of drinking valves. In this manner, the heat from the electric heater heats the water in the distribution arm and the heat transfer pin moves the heat from the distribution arm into the drinking valve which delays or prevents the valve from freezing.

The prior art embodiments, such as the one shown in FIGS. 1 to 3, suffered from difficult construction and the use of various liquid sealants that were difficult to apply or were shipped with the parts to be assembled by the end user. The backyard chicken farmer is one who desires a kit for easy assemble which requires little or no effort to assemble.

In this case, the inventors have created such an easy to assemble kit which is void of chemical sealants and can be assembled by hand.

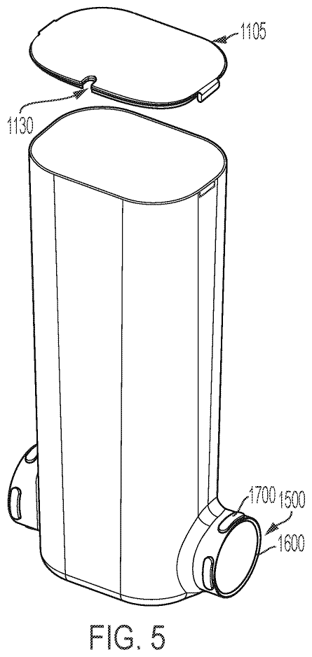

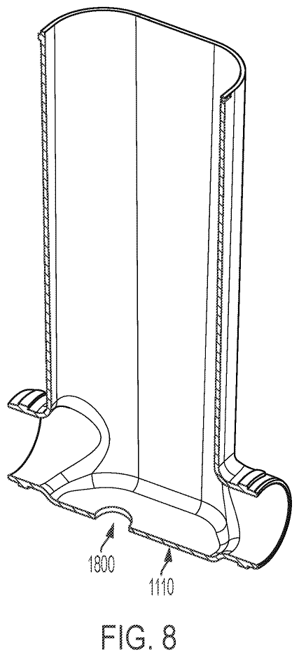

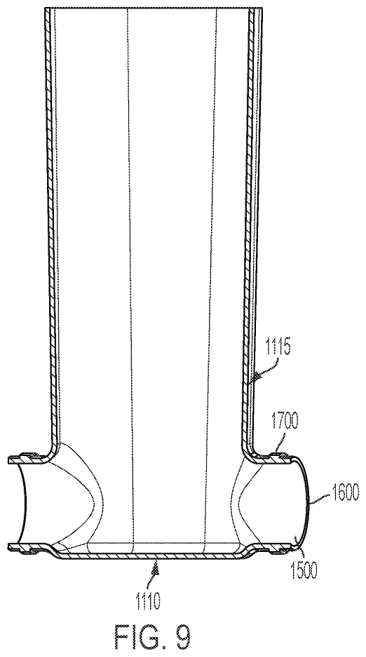

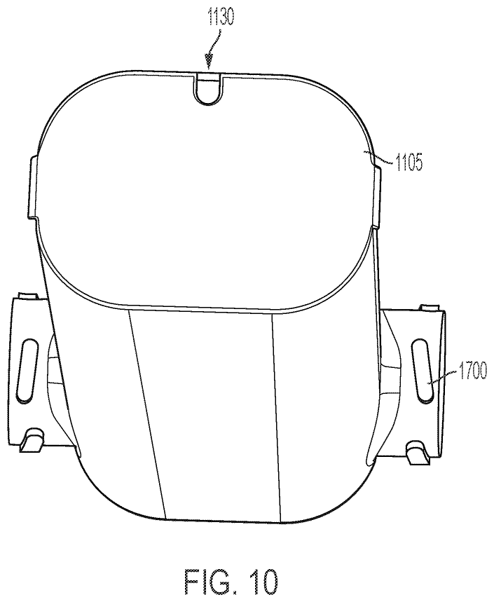

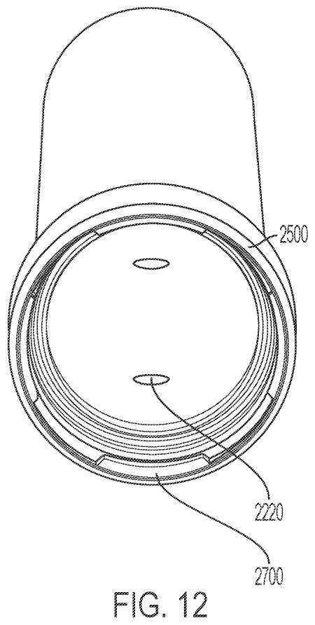

As shown in FIGS. 4 to 13 show an improved assembly and kit for assembly comprising a water receiver 1100 with an optional lid 1105 and vent 1130. The shown improved water receiver is of unitary construction and has two connector ports, one of which is shown as 1500 in FIG. 5.

Unlike the prior art connection to the distribution arm which contained four components (water receiver, union, reducer, and tube), sealed with PVC adhesive, the improved connection is provided by at least two lugs which angle away from the open end of the connector port. Shown as 1700 in FIG. 5, these lugs are located on the outside of the rounded connector wall. In another embodiment, they could be located on inside of the distribution arm that connects with the connector port.

(1600) is a groove or concave portion for a seal, like an O-ring or a gasket. When the distribution arm is rotated in connection with the lugs, the lug guides a groove in the distribution arm and tightens, also known as applying pressure to, the seal between the connector port and the distribution arm. This compression applies the pressure indicated in the direction of the arrow (1650)

An alternate embodiment is to have a thread circumscribing the circumference of the connector port. The difference between a lug and a thread is that the thread is continuous tracing around the connector port many times whereas the lug is discontinuous and the distribution arm only travels a portion around the connector, thus controlling the amount of torque or pressure put on the seal.

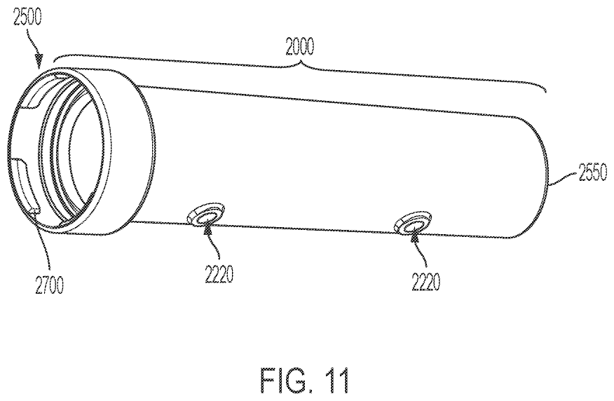

The distribution arm labeled 2000 (FIGS. 11 to 13), has at least one distribution port (2220) which is a hole the wall of the distribution arm and receives the drinking valve which is not shown in the FIG. s, but is fully described and known in the prior art. 2500 is the first end of the distribution arm opposite the second end, which is closed off preventing water flow. The first end has connecting lug (2700) and a seal groove 2600 for holding the O-ring or seal to be compressed as the distribution arm is twisted around the connector port and tightened.

The cap may also be threaded onto the distribution arm sidewall. In such an embodiment the outer surface of the distribution arm sidewall may have male threads while the portion of the distribution arm cap that fits around the outer surface of the distribution arm sidewall has female threads and the male threads of the distribution arm sidewall are mated to the female threads of the distribution arm cap. In an alternative embodiment the distribution arm cap is bonded to the distribution arm using a sealant material such as silicone, PVC cement, or both.

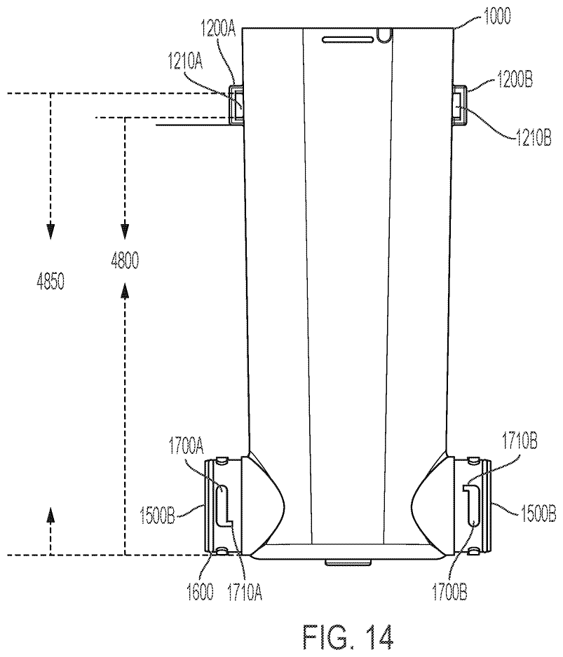

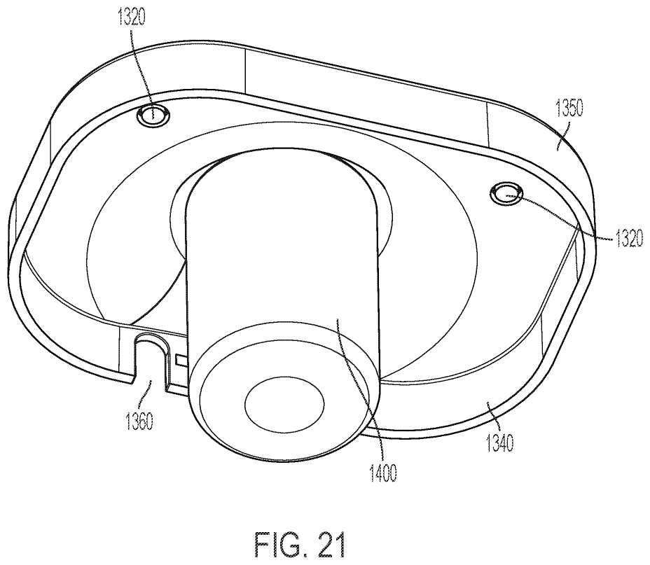

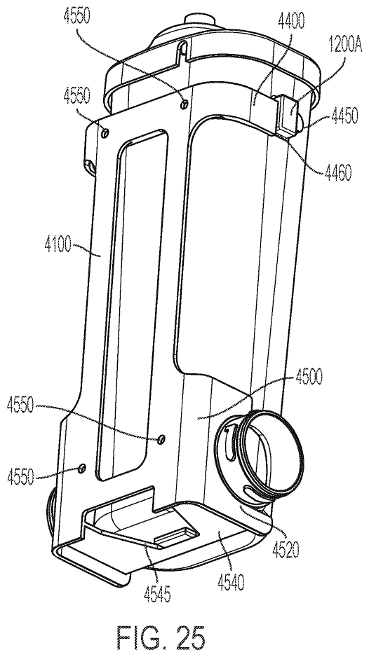

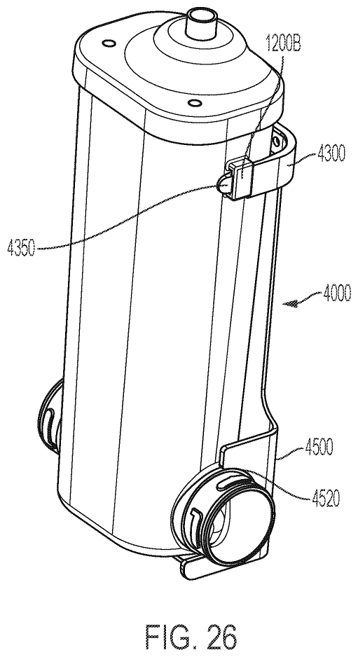

FIGS. 14 to 28 show embodiments of a straight lug design, a lug stop design, and a lug lock design. Also shown is a wall mount with brackets attached to the reservoir.

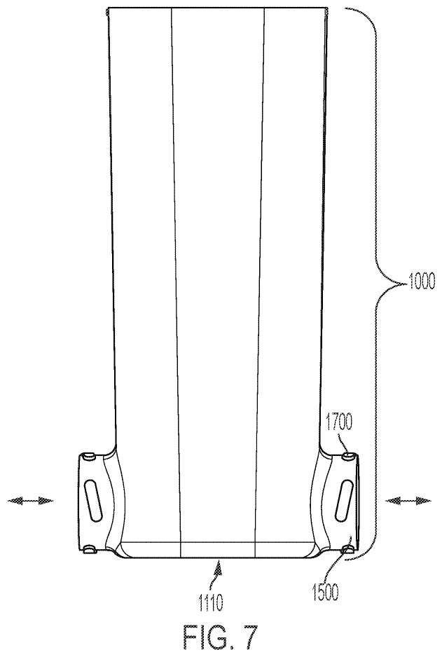

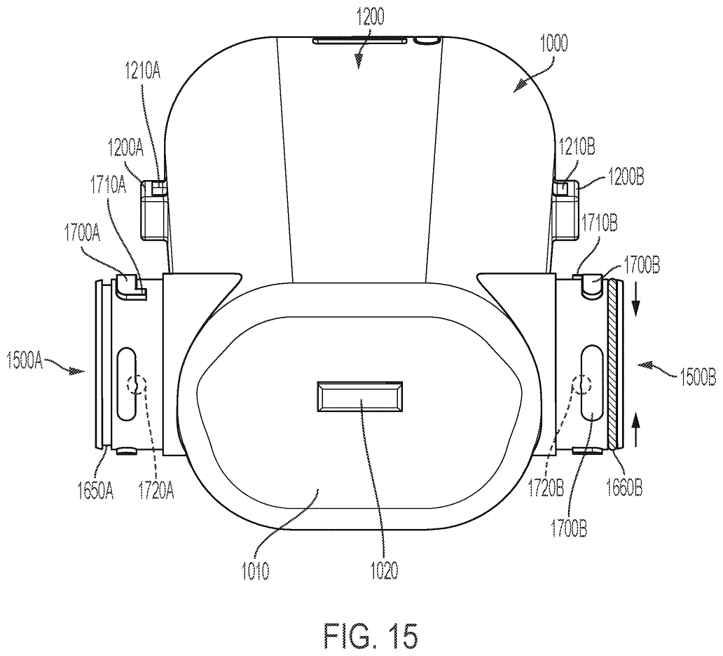

FIGS. 14 to 16 the straight lug design (1700). Instead of angling around the port, the lugs are straight, i.e. Parallel with the port inlet. The angle is not needed due to the placement of O-ring groove (FIG. 15; 1650A, 1650B, FIG. 15) around the respective port (1500A and 1500B). The O-ring placement is shown in (FIG. 15, with only 1660B show). Where the angled lug compresses the O-ring against the port in the tightening direction is shown in the bi-directional arrows in FIG. 7, the O-ring with the straight lug is compressed towards the center of the port as shown in the arrows in FIG. 15.

FIGS. 14 to 16 also depict the lug stop (1710A and 1710B). The lug stop is to stop the distribution arm rotation. One of ordinary skill can see that the lug stop can also be placed on the angled lug to prevent over compression of the O-ring.

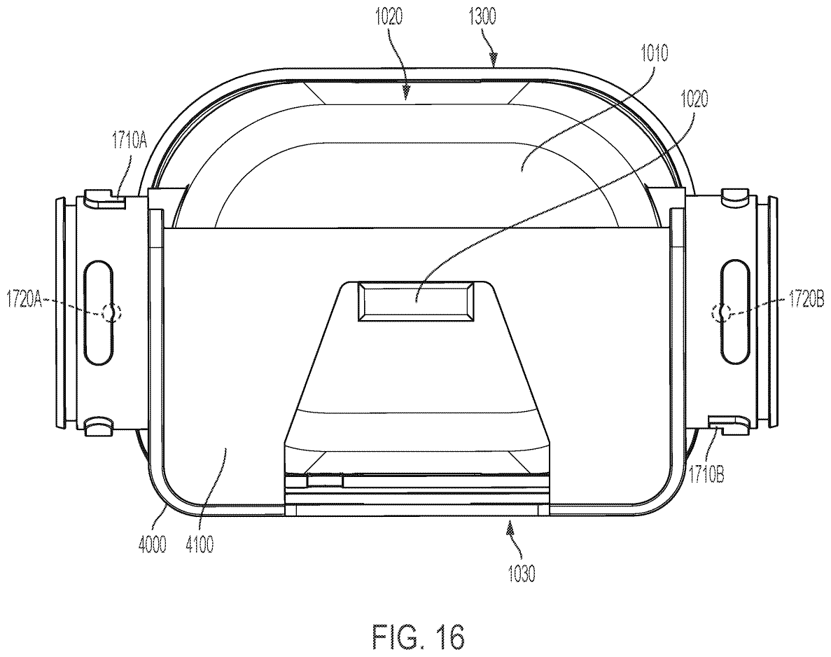

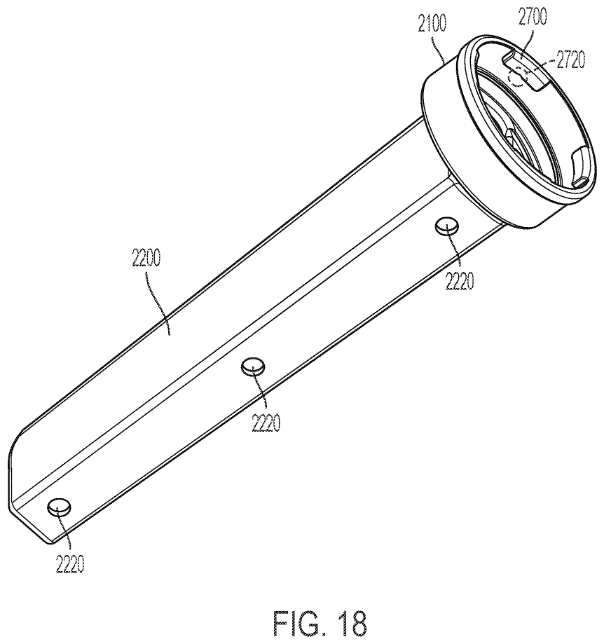

1720A and 1720B are lug locks that are more prominently shown in FIG. 16. The lug lock is a sharp protrusion from the side of the lug. It interacts with lug notch (FIGS. 18, 2720). The lug lock keeps the distribution arm from rotating on its own or due to vibrations.

Mounting attachments 1200A and 1200B are also shown in FIGS. 14 and 15.

There is a mounting slot or hole (1210A, 1210B) on the water reservoir for the bracket tab to enter. 4850 and 4800 are the distances from the bottom of the port to the top of the mounting bracket slot or hole and bottom of the mounting bracket slot or hole, respectively.

FIG. 16 shows a bottom view of the reservoir (1000) mounted in the mounting bracket (4000). 1300 is the reservoir lid surrounding the reservoir front side (1020) and the back side (1030). The bottom of the reservoir (1010) has a mounting lock (1020) protruding from the bottom. The mounting bracket base (4100) has a cut away so that the mounting lock can protrude into the cut away and prevent movement of the reservoir bottom from the mounting bracket.

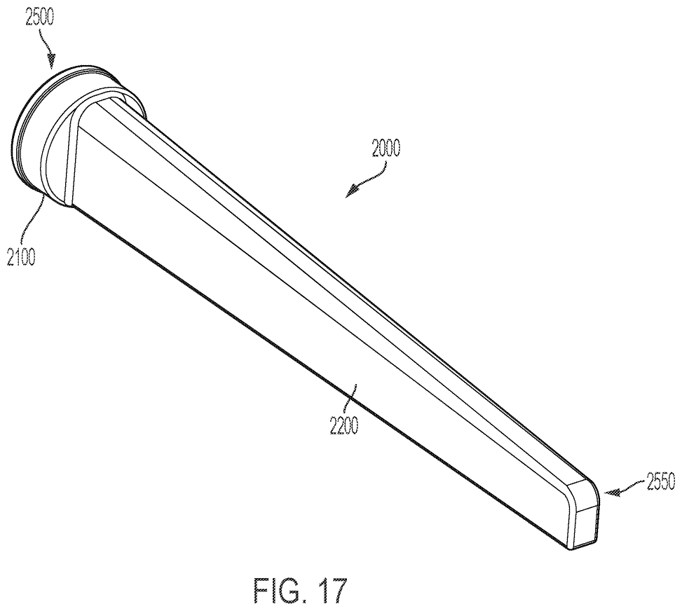

FIGS. 17-19 show an alternative distribution arm (2000) with having a distribution arm connector (2100) and a distribution arm carrier (2200). The distribution arm end, which is opposite the connector is 2550.

As shown in FIG. 18, the distribution arm connector (2100) is configured to interact with the lugs on the reservoir port. Distribution arm lug (2700) has a lug notch (2720) to interact with the lug lock on the reservoir port. It should be evident that the lug lock could be on the distribution arm lug with the lug notch on the lug on the reservoir port. It should also be evident the straight and angled lug configurations can be used with O-ring around the port. It should also be evident that the lug stop, and/or the lug lock/lug notch can be used with either O-ring compression strategy or with any shape of the distribution arm.

FIG. 18 also shows (2220) valve receivers for the insertion of the drinking valves. The valve receiver can also be threaded to receive a threaded drinking valve.

A mentioned earlier, the connection of the distribution arm can be configured so that the drinking valves do not point straight down to the ground. The drinking valves are preferably angled so that tip of the valve extends beyond the imaginary line formed by the ground to the edge distribution arm (Lg, FIG. 19) along the line of sight (L₂) from the ground. This is accomplished by placing the drinking valve at an angle to the same imaginary line. Because the line from the ground is perpendicular to the ground, the angle mentioned earlier is the same angle. This angle (Θ, FIG. 19) is preferably in the range of 5 to 45 degrees. In this manner, the drinking zone directly above the drinking fowl is not covered by the distribution arm. The fowl prefer this as it allows them to watch the sky for predators.

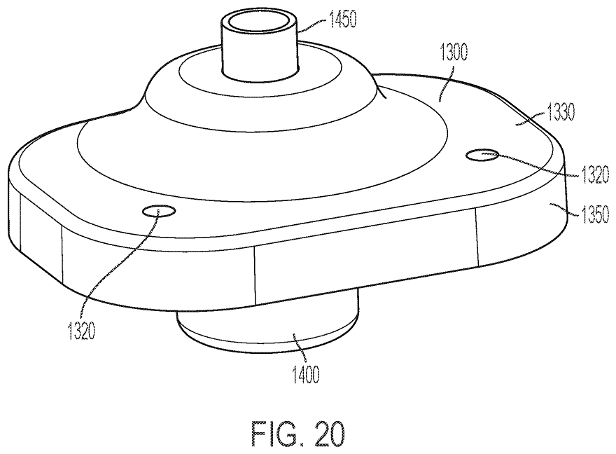

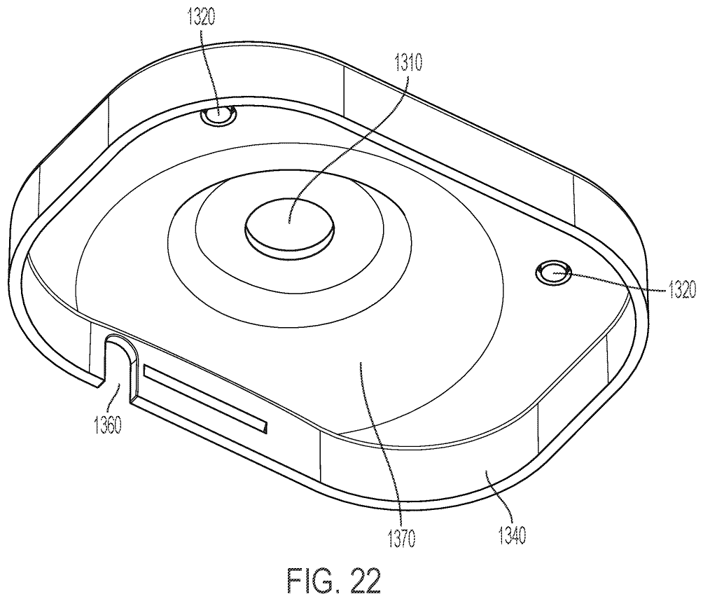

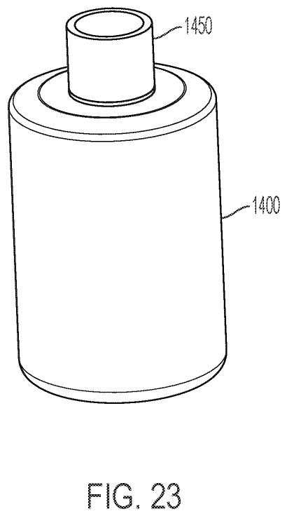

FIGS. 20 to 22 shows the lid with the water level control device attached. The inlet port (1450) of the water level control device (1400) (FIG. 23) is shown passing through lid (1300). The lid had two vent holes (1320) a top side (1330), an underside (1370) an outside wall (1350) and an inside wall (1340). It also has an inlet notch (1360) for electrical lines, probes or other monitoring devices. As shown in FIG. 22, there is an underside opposite the top side. The water level control device can be fixed via an adhesive or the inlet port could be threaded and a nut used to tighten the device to the lid.

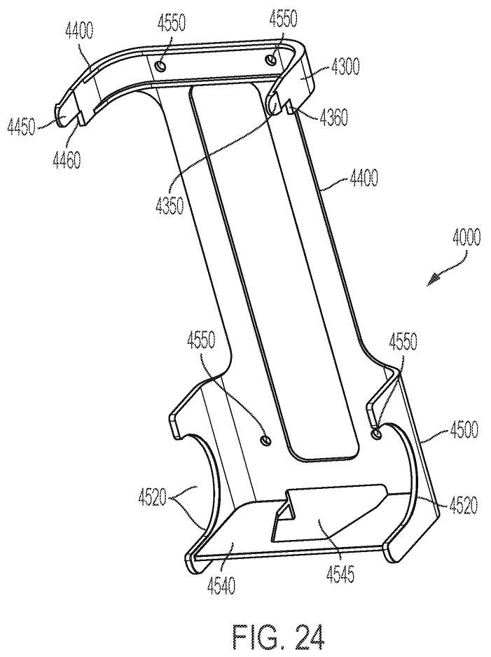

FIGS. 24 to 26 show the mounting bracket (4000). The mounting bracket has a base (4500) which is attached to the cradle (4520). The base has a support (4540) with a cutaway hole (4545). The mounting bracket further has a back (4100) attaching the base to the mounting bracket top.

The top of the mounting bracket has two locking arms (4400, 4300) that slide on either side of the reservoir. There are two locking tabs (4450, 4350) that slide into the mounting bracket (1200A, 1200B) slots or holes (1210A, 1210B). There are through holes (4550) for fixing the mounting bracket to a wall or post.

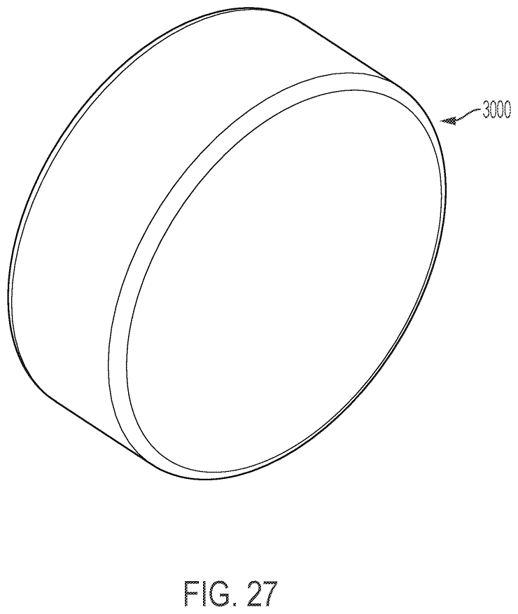

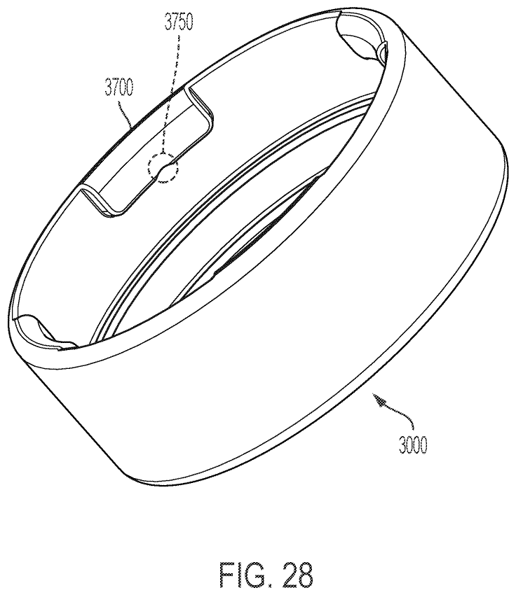

FIGS. 27 and 28 are to an end cap (3000) used to close off one of the distribution ports. Like the distribution arm connector, it has lugs (3700), which could be angled or straight, to seal the port leaking water. There is also the optional lug notch (3750) or lug lock show in the FIG. 28.

Based upon the figures and explanation above it is clear that the improved water dispenser will have a water reservoir comprising a top end, a bottom end, and at least one sidewall, a connector port. This water reservoir will have at least one connector port and at least one distribution arm. The connector port may have straight or angled lugs. At least one of the straight or angled lugs may have a lug stop. The distribution arm may have a lug which may also be straight or angled. The distribution arm lug may or may not have a lug lock.

The distribution arm and the connector can be configured to mate or align so that the drinking valves are preferably angled so that tip of the valve extends beyond the imaginary line formed by the ground to the edge distribution arm (Lg, FIG. 19) along the line of sight (L₂) from the ground. This is accomplished by placing the drinking valve at an angle to the same imaginary line. Because the line from the ground is perpendicular to the ground, the angle mentioned earlier is the same angle. This angle (O, FIG. 19) is preferably in the range of 5 to 45 degrees.

The improved water dispenser will also have a gasket, such as an O-ring which is compressed in the tightening direction as shown in the bi-directional arrows in FIG. 7 or in the radial direction as shown by the two facing arrows in FIG. 15.

The improved water dispenser of any of the above configurations will have a water level control mechanism which may a valve at the bottom of the water reservoir, or a valve located at the top of water reservoir, or in the lid.

The water reservoir of any configuration may or may not have mounting attachments. If there are mounting attachments, the kit may optionally include a mounting bracket.

1-12. (canceled)

13. A device for dispensing water, comprising:
a water reservoir having opposed top and bottom ends and at least one water reservoir sidewall, wherein at least one connector port is formed in the at least one water reservoir sidewall;
at least one water distribution arm having opposed open and closed ends and at least one water distribution arm sidewall, wherein at least one water distribution port is formed in the at least one water distribution arm sidewall; and
at least one drinking valve received within the at least one water distribution port,
wherein the open end of the at least one water distribution arm is releasably connected to, and releasably mated with, the at least one connector port of the water reservoir.

14. The device for dispensing water as recited in claim 13, wherein the at least one connector port comprises a lug.

15. The device for dispensing water as recited in claim 14, wherein the lug is an angled lug or a straight lug.

16. The device for dispensing water as recited in claim 14, wherein the lug has a lug stop.

17. The device for dispensing water as recited in claim 13, wherein the at least one water distribution arm has a lug.

18. The device for dispensing water as recited in claim 17, wherein the lug of the at least one water distribution arm has a lug stop and/or a lug lock.

19. The device for dispensing water as recited in claim 13, further comprising a gasket for forming a seal between the at least one connector port and the at least one water distribution arm.

20. The device for dispensing water as recited in claim 13, further comprising a water level control mechanism.

21. The device for dispensing water as recited in claim 20, wherein the water level control mechanism is attached to the water reservoir.

22. The device for dispensing water as recited in claim 13, wherein the top end of the water reservoir is open, the device for dispensing water further comprising a lid for releasably covering the top end of the water reservoir.

23. The device for dispensing water as recited in claim 13, wherein further comprising a mounting bracket for mounting the water reservoir on a support surface.
